(19) United States
(12) Patent Application Publication
(10) Pub. No.: US 2016/0144840 A1
(43) Pub. Date: May 26, 2016

(54) Method And Device For Generating An Emergency Braking Signal For A Vehicle And Method For Initiating A Vehicle Emergency Braking Procedure

(71) Applicant: ZF FRIEDRICHSHAFEN AG, Friedrichshafen (DE)

(72) Inventor: Ralf PFEIFER, Diepholz (DE)

(73) Assignee: ZF Friedrichshafen AG, Friedrichshafen (DE)

(21) Appl. No.: 14/898,569

(22) PCT Filed: May 26, 2014
(86) PCT No.: PCT/EP2014/060770

§ 371 Date: Dec. 15, 2015

(30) Foreign Application Priority Data
Jun. 27, 2013 (DE) 10 2013 212 364.7

(51) Int. Cl. B60T 8/1761; B60T 17/22; B60T 8/171; B60T 7/12

(52) U.S. Cl. CPC B60T 8/17616; B60T 7/12; B60T 17/22; B60T 8/171

(57) ABSTRACT

A method for generating an emergency braking signal for a vehicle is proposed. The vehicle has a main brake system and a drive system thereby. The method is characterized by a step for detecting a vehicle emergency, representing a reduced or impaired braking effect of the main brake system, using at least one sensor signal that has been read in, and a step for generating the emergency braking signal as a function of the detected vehicle emergency. The main brake system, the drive system, a supplementary brake system and/or at least one further on board installation of the vehicle can be activated by means of the emergency braking signal thereby, in order to cause or support an emergency braking procedure of the vehicle.

The present invention relates to a method for generating an emergency braking signal for a vehicle, a device for generating an emergency braking signal for a vehicle, a method for initiating an emergency braking procedure, and a corresponding computer program product.

According to investigations by the Federal Office of Statistics, for automobile accidents resulting in personal injury, brake failure, by way of example, makes up 1.2 to 1.9% of the total per year. As such, technical failures of brake systems or malfunctions, for example, may lead to abrupt brake failure, in particular over a longer gradient or suchlike. Drivers may also become impaired, due to epileptic seizures, blackouts, heart attacks, unexpected effects of medication, or gross negligence.

DE 10 2009 036 348 A1 discloses a method for controlling braking forces on a vehicle with a determination of an intentional expected deceleration for the vehicle and with a subsequent automatic impact on the engine and/or the transmission based on this (intentional) expected deceleration, having the goal of modifying the drag torque acting on the motor vehicle such that the (intentional) expected deceleration is attained. For this, an engine braking effect and service brakes are coordinated to one another such that the service brake is relieved of the portion assumed by the engine braking.

Based on this, the present invention provides an improved method for generating an emergency braking signal for a vehicle, an improved device for generating an emergency braking signal for a vehicle, an improved method for initiating a vehicle emergency braking procedure, and an improved computer program product in accordance with the main claims. Advantageous designs can be derived from the dependent claims and the following description.

According to embodiments of the present invention, a strategy can be provided, in particular for supporting emergency braking in an automobile accident, in the event that the driver's functioning becomes impaired, or with a failure of the main braking systems in motor vehicles having transmissions without the possibility of direct manual intervention, for example. For this, energy can be supplied to a drive unit designed as an internal combustion engine or an electric motor in order to brake, wherein the activation occurs via a strategy that detects a vehicle emergency. It may also be provided thereby that a drive system of a vehicle is not, or is not only, implemented for regeneration, but rather, receives energy for braking in a vehicle emergency.

In the field of utility vehicles, service brakes are typically supplemented, in particular, by sustained-action brake systems, such as exhaust valves, retarders and suchlike. In the field of passenger cars, where for the most part, the driver is not a professional driver, and a spectrum between regular and orderly maintenance and irregular or even negligent maintenance may be large, such beneficial supplementary brake systems are typically lacking. In accordance with embodiments of the present invention, comparably functioning strategies or mechanisms can be provided, in particular with sustained-action brake systems, which can securely and reliably ensure a braking in a vehicle emergency. In doing so, an emergency braking can be advantageously caused or supported, wherein, with respect to costs and uses, it is of little consequence in an approach of this type that components of the vehicle are operated beyond their specifications, specifically the engine, transmission and drive train, wherein avoidance of danger to life and limb compensates for natural damage to vehicle components such as the engine and transmission.

Advantageously, vehicle emergency braking can thus be securely and reliably implemented or at least supported in accordance with embodiments of the present invention, even when a driver or a main brake system of the vehicle ceases to function. In particular, in the event of a loss of control of the vehicle caused by the absence of a braking effect, driving safety can be increased in this manner, and the risk of an accident can be minimized. For this, first a vehicle emergency can be reliably and safely detected, and based on this, an appropriate means of avoiding danger can be initiated.

Furthermore, vehicle drivers and passengers may be provided with more control, in particular with automatic transmissions in hazardous situations when the brakes fail, in terms of reaching an emergency brake. As such, despite a development of secure systems, and in the framework of new technologies, functions that are normally inaccessible can now be made accessible to the driver of a vehicle. By way of example, it may be provided that automatic transmissions also allow a direct manual intervention in the shifting of gears, by means of which an engine braking effect can be increased in order to at least support the emergency brake, even when the engine would be over-revved thereby. In this situation, damage to individual components of the vehicle, however, is the lesser evil. With a synchronized manual transmission, for example, there is usually nothing to prevent a gear shifting that results in an over-revving.

An advantageous method for generating an emergency braking signal for a vehicle, wherein the vehicle has a main brake system and a drive system, is characterized in that the method includes a step for detecting a vehicle emergency, representing a limited or impaired braking effect of the main brake system, using at least one sensor signal, and a step for generating the emergency braking signal as a function of the detected vehicle emergency, wherein the main brake system, the drive system, a supplementary brake system and/or at least one further on board installation of the vehicle can be activated by means of the emergency braking signal in order to cause an emergency braking procedure of the vehicle, or to support such.

A vehicle can be understood herein to be a road vehicle for passenger transportation and or transportation of goods, such as a passenger car, a truck, or another utility vehicle. The main brake system can include a service brake of the vehicle. The drive system can comprise an engine, an engine control, a valve control of the engine, a transmission, a transmission control, a differential and/or a drive train of the vehicle. The engine can be an internal combustion engine, an electric motor, a hybrid motor, or another type of engine. The transmission can be a manual transmission, a semiautomatic transmission, or an automatic transmission. The supplementary brake system can be a retarder, an exhaust valve or suchlike. The at least one further on board installation can be an air conditioner, a generator-recuperation device or the like, for example, wherein the further on board installation is supplied with power from the engine output. The vehicle emergency can represent a situation in which a braking effect of the main brake system is limited or impaired due to failure, or partial failure, of the main brake system or the vehicle driver. The emergency braking signal represents a datum for reacting to the vehicle emergency. In response to an activation by means of the emergency braking signal, the main brake system, the drive system, the supplementary braking mechanism and additionally or alternatively, the at least one further on board installation of the vehicle, can execute an operation or a function such that the emergency braking procedure of the vehicle is caused or supported.

According to one embodiment, in the detection step, a failure of the main brake system can be detected as a vehicle emergency, using at least one sensor signal that has been read in, which represents brake slippage, a hydraulic brake circuit system pressure, an engine rotation speed, at least one property of an actuation procedure on a gear selection device, and additionally or alternatively, a datum from a driver assistance system of the vehicle. The failure of the main brake system can be partial or complete. The gear selection device can be or is provided with at least one sensor thereby, which is designed to detect an acceleration and/or contact during an actuation procedure. The at least one property of an actuation procedure on a gear selection device, in particular a shift lever or gear selection lever, can include an actuation force, an actuation speed, a shifting frequency and/or a plausibility of the actuation procedure, in particular with respect to the engine rotation rate, the brake slippage, the hydraulic brake circuit system pressure and/or data from the driver assistance system.

In particular, situations are detected in which an anti-lock braking system (ABS) of the vehicle, for example, on loose surfaces, e.g. a snow-covered road, sand, gravel or suchlike, causes an undesired prolongation of the braking path. As a result, a situation of this type can be counteracted, if necessary, in which, starting at a critical gradient, the vehicle is unintentionally accelerated, even though the driver fully applies the brakes.

An emergency braking signal can be generated thereby, in the generation step, as a function of the detected failure of the main brake system, by means of which the drive system, the supplementary brake system, and additionally or alternatively, the at least one on board installation of the vehicle can be activated, in order to cause or support the emergency braking procedure. An embodiment of this type offers the advantage that even with brake failure, the vehicle can brake securely, be slowed, or can be brought to a standstill in the framework of the emergency braking procedure that can be initiated. As a result, the danger of a serious accident resulting from the brake failure can be minimized. With a partial brake failure, a driver assistance system, in particular a driving dynamics regulating system or an electronic stability program (ESP), can be activated by means of the emergency braking signal, in order to control brake circuits that remain functional.

In the detection step it is also possible to detect a failure on the part of the driver of the vehicle as a vehicle emergency, using at least one sensor signal, received from an interior camera, a contact sensor on a steering wheel, a contact sensor on a gear selection device, and additionally or alternatively, a driver assistance system of the vehicle. In doing so, the at least one sensor signal can also represent an actuation of the gear selection device and/or an actuation of a hand brake or parking brake by a passenger of the vehicle. The interior camera can be designed to recognize a behavior pattern of the driver, and if applicable the passengers, in recorded image data that indicate a driver impairment. Contact sensors on the steering wheel and/or the gear selection device can be designed to recognize an actuation by the driver, or if applicable, the passengers. An embodiment of this type offers the advantage that driver impairment can be detected as a vehicle emergency, wherein the detection can occur reliably and precisely based on a sensor signal or a combination of sensor signals with greater validity.

In particular in the generating step, an emergency braking signal can be generated, by means of which at least one transmission mechanism of the vehicle can be activated in order to increase a tire slippage, a drag torque, and additionally or alternatively, an engine brake torque, in order to cause or support the emergency braking procedure of the vehicle. The at least one transmission mechanism can be a part of the drive system of the vehicle. The at least one transmission mechanism can be a control device and/or an assembly in a drive train of the vehicle. An embodiment of this type offers the advantage that the emergency braking procedure of the vehicle functions reliably, or can at least be supported, even when the main brake system fails, by using a strategy of this type.

Furthermore, an emergency braking signal is generated in the generating step, by means of which an engine control device, an exhaust valve control device, and additionally or alternatively, a valve control device of the drive system, can be activated in order to increase an engine drag torque and additionally or alternatively, an engine brake torque, in order to cause or support the emergency braking procedure of the vehicle. An embodiment of this type offers the advantage that, even when the main brake system fails, the emergency braking procedure of the vehicle can be reliably effected or at least supported by means of a strategy of this type for controlling the engine.

An emergency braking signal can also be generated in the generating step, by means of which at least one on board installation supplied with power from an engine in the vehicle can be activated for acquiring energy for supporting the emergency braking procedure of the vehicle. An embodiment of this type offers the advantage that an activation, or switching on, in this manner, of further loads that are powered by the engine, can increase an engine braking effect, because an engine output to the drive is reduced.

In addition, in the generating step an emergency braking signal can be generated, by means of which at least one lighting system and/or a warning system of the vehicle can be activated, in order to activate the hazard lights, a honking of the horn, and additionally or alternatively, a headlamp, in order to support an emergency braking procedure of the vehicle. An embodiment of this type offers the advantage that attention can be directed to the vehicle emergency, and other road users can be warned, in order to make space for the vehicle, or suchlike.

An advantageous method for initiating an emergency braking procedure of a vehicle, wherein the vehicle includes a main brake system and a drive system, is characterized in that the method includes a step for generating an emergency braking signal for a vehicle in accordance with an embodiment of the aforementioned method for generating, and a step for activating the main brake system, the drive system, the additional brake system and/or the at least one further on board installation of the vehicle, by means of the emergency braking signal, in order to cause or support the emergency braking procedure of the vehicle.

In conjunction with the method for initiating an emergency braking procedure, an embodiment of the method described above, for generating an emergency braking signal, can be advantageously executed in order to advantageously initiate an emergency braking procedure.

An advantageous device for generating an emergency braking signal for a vehicle, wherein the vehicle has a main brake system and a drive system, has the following features:

a device for detecting a vehicle emergency, representing a limited or impaired braking effect of the main brake system, using at least one sensor signal that has been read in; and

a device for generating the emergency braking signal as a function of the detected vehicle emergency, wherein the main brake system, the drive system, a supplementary brake system and/or at least one further on board installation of the vehicle can be activated by means of the emergency braking signal, in order to cause or support an emergency braking procedure.

The device for generating an emergency braking signal can be designed to execute or implement the step of the method specified above for generating an emergency braking signal. In particular, the device can include mechanisms that are designed to each execute one step of the aforementioned method. The basic objective of the invention can also be achieved by means of this embodiment variation of the invention in the form of a device.

The device for generating an emergency braking signal can be a part of a control device or suchlike. A device can also be understood in the present context to mean an electric device or control device, which processes at least one sensor signal, and as a function thereof, emits an emergency braking signal. The device can have an interface, which can be designed in terms of hardware or software. With a hardware design the interfaces can, for example, be a part of a so-called system ASIC, which comprises various functions of the device. It is also possible, however, that the interfaces are distinct, integrated circuitries, or are composed at least from discrete components. With a software type design, the interfaces can be software modules, which are present on a microcontroller, for example, in addition to other software modules.

A computer program product having programming code, which is stored on a machine-readable carrier, such as a semiconductor memory, a hard disk, or an optical memory, and is used for executing an embodiment of an aforementioned method, is also advantageous when the program is executed on a computer or a device.

The invention shall be explained, by way of example, in greater detail on the basis of the attached drawings. Therein:

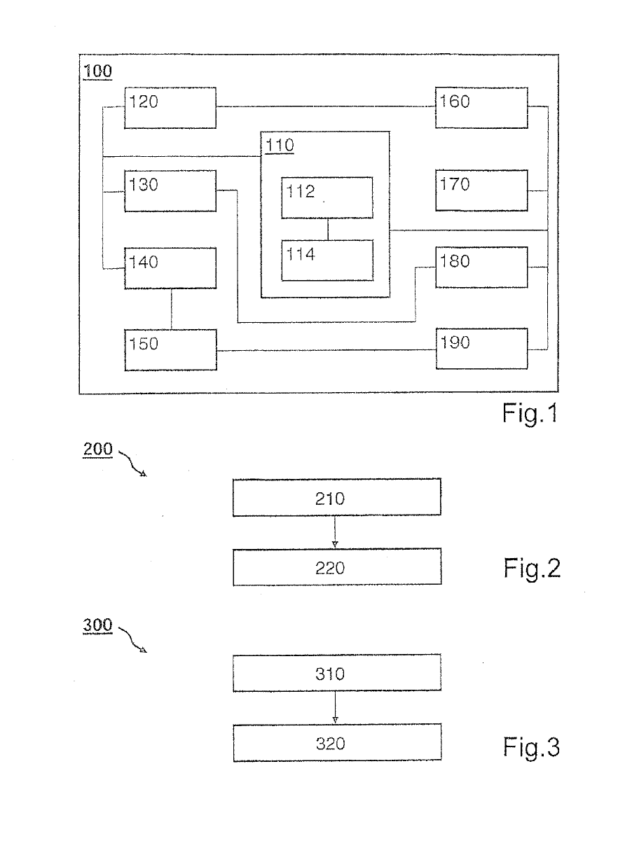

FIG. 1 shows a vehicle having a device for generating an emergency braking signal in accordance with an exemplary embodiment of the present invention;

FIG. 2 shows a flow chart for a method for generating an emergency braking signal in accordance with an exemplary embodiment of the present invention; and

FIG. 3 shows a flow chart for a method for initiating an emergency braking signal in accordance with an exemplary embodiment of the present invention.

In the following description of preferred exemplary embodiments of the present invention, elements depicted in the various figures having similar and identical functions shall be provided with identical reference symbols, wherein a repetition of the description of such elements shall be omitted.

FIG. 1 shows a vehicle 100 having a device 110 for generating an emergency braking signal in accordance with an exemplary embodiment of the present invention. Of the vehicle, shown are: the device 110 with a detection system 112, as well as a generating system 114, a brake system sensor 120, an engine rotation rate sensor 130, an actuation sensor 140, a gear selection device 150, or a shift lever or selection lever, respectively, a main brake system 160, or service brake or brake system, respectively, a supplementary brake system 170, an engine 180, and a transmission 190.

The device 100 has the detection system 112 and the generating system 114. The brake system sensor 120, the engine rotation rate sensor 130 and the actuation sensor 140 are connected to the device 100 by means of at least one communication interface, e.g. an electrical cable, a wireless connection, or suchlike. The actuation sensor 140 is disposed in the region of the gear selection device 150, and/or connected thereto by means of a communication interface. Furthermore, the main brake system 160, the supplementary brake system 170, the motor 180 and the transmission 190 are connected to the device 100 by means of at least one further communication interface, e.g. an electrical cable, a wireless connection, or suchlike. Furthermore, the brake system sensor 120 is connected to the main brake system 160, the engine rotation rate sensor 130 is connected to the engine 180, and the gear selection device 150 is connected to the transmission 190, each by means of the communication interfaces. The engine 180 and the transmission 190 represent a drive system of the vehicle 100 thereby.

The brake system sensor 120 is designed to detect an operational state of the main brake system 160, and to provide a sensor signal that represents the operational state of the main brake system 160. The engine rotation rate sensor 130 is designed to detect the engine rotation rate of the engine 180, and to provide a sensor signal that represents the engine rotation rate of the engine 180. The actuation sensor 140 is designed to detect at least one property of an actuation procedure of the gear selection device 150, and to provide a sensor signal that represents the at least one property of the actuation procedure of the gear selection device 150.

The device 110 is designed to generate an emergency braking signal for the vehicle 100. The device 110 is designed thereby to read at least one sensor signal from the brake system sensor 120, the engine rotation rate sensor 130 and, additionally or alternatively, the actuation sensor 140. The detection system 112 of the device 110 is designed thereby to detect a vehicle emergency that represents a limited or impaired braking function of the main brake system 160 using the at least one sensor signal that has been read in. The generating system 114 of the device 110 is designed to generate the emergency braking signal as a function of the detected vehicle emergency. The main brake system 160, the drive system 180, 190, the supplementary brake system 170, and additionally or alternatively, at least one further on board installation (not shown in FIG. 1) of the vehicle can be activated thereby by means of the emergency braking signal, in order to cause or support an emergency braking procedure of the vehicle 100. Furthermore, the device 100 is designed to emit the emergency braking signal for activating the main brake system 160, the supplementary brake system 170, the engine 180, and additionally or alternatively, the transmission.

In accordance with an exemplary embodiment, the detection system 112 is designed to detect an impairment of a driver of the vehicle 100 using at least one read sensor signal received from an interior camera, a contact sensor on a steering wheel, the actuation sensor 140, or contact sensor on the gear selection device 150, and additionally or alternatively, a driver assistance system of the vehicle 100. The detection system 112 is also designed, in accordance with an exemplary embodiment, to detect impairment of the driver of the vehicle based on an actuation of a hand brake of the vehicle 100 by a passenger. The detection system 112 is also designed to detect a situation as a vehicle emergency by means of contact sensors and, if applicable, vehicle interior monitoring, in which the driver is impaired and the passengers cannot reach the hand brake or the service brake. The actuation sensor 140 is also designed, by way of example, to detect the placement of a hand on the gear selection device 150, in order to be able, in particular, to distinguish between an actuation by the driver and an actuation by the passenger.

According to one exemplary embodiment, the detection system 112 is designed to detect a main brake system 160 failure as a vehicle emergency using the at least one sensor signal that has been read in. The at least one sensor signal represents a brake slippage, a hydraulic brake circuit system pressure, an engine rotation rate, at least one property of an actuation procedure at the gear selection device 150, and additionally or alternatively, a datum of a driver assistance system (not shown in FIG. 1) of the vehicle 100 thereby. The generating system 114 is designed thereby to generate an emergency braking signal as a function of the detected main brake system 160 failure, by means of which the drive system 180, 190, the supplementary brake device 170, and additionally or alternatively, the at least one further on board installation of the vehicle 100 can be activated, in order to cause or to support the emergency braking procedure.

The main brake system 160 failure can be attributed, for example, to one of the following causes: with an abrupt main brake system 160 failure, vapor bubbles may be formed in a brake fluid, caused by a hygroscopic brake fluid, e.g. glycol ether, that has drawn too much water, because a change interval has been exceeded, or leakages have promoted an intake of water. This may also result in so-called brake fade, up to the point where the brakes fail entirely, caused, for example, by sustained braking, a poor driving style with many acceleration and baking phases, driving with a trailer that does not have trailer brakes, or suchlike. Furthermore, technical brake failure of at least one brake circuit may occur due to leakages in the hydraulic circuit, ruptured hoses, or driving with worn brake disks or linings.

According to one exemplary embodiment, the detection system 112 is designed to detect a main brake system 160 failure as a vehicle emergency using a coinciding of some or all of the following symptoms: strong braking on the part of the driver, detectable by brake slippage or, alternatively, by hydraulic system pressure in brake circuits of the main brake system 160. The driver attempts to downshift manually with an automatic transmission, repeats this frequently, attempting to shift into R or P, or suchlike. The engine rotation rate has reached an upper rotation rate limit, such that further downshifting would lead to an over-revving of the engine 180. If applicable, notifications from a driver assistance system occurring on a vehicle bus, e.g. an ESP, regarding a function malfunction of the main brake system 160. The actuation sensor 140 reports inputs of the driver at the gear selection device 150, or the shift lever, thereby, supported in particular by a behavior observation of the shift lever actuation, e.g. regarding actuation force, movement speed, shifting frequency and sensitivity of the shifting operation at the gear selection device 150. Thus, by means of the actuation sensor 140, for example, a measurement of a force and/or speed of an actuation of the gear selection device 150 occurs, wherein a measurement parameter of this type serves as a guide parameter for a regulation of the emergency braking procedure. The actuation sensor 140 has, for example, at least one force sensor, for measuring a quantity of an actuation force.

According to one exemplary embodiment, the generating system 114 is designed to generate an emergency braking signal, by means of which the transmission 190 of the vehicle can be activated in order to increase a tire slippage, a drag torque, and additionally or alternatively, an engine brake torque, in order to cause or support the emergency brake procedure of the vehicle 100.

According to one exemplary embodiment, the generating system 114 is designed to generate an emergency braking signal, by means of which an engine control device, an exhaust valve control device, and additionally or alternatively, a valve control device of the engine 180 can be activated, in order to increase an engine drag torque, and additionally or alternatively, an engine brake torque, in order to cause or support the emergency braking procedure of the vehicle 100.

According to one exemplary embodiment, the generating system 114 is designed to generate an emergency braking signal, by means of which at least one of the on board installations supplied with power by the engine 180 of the vehicle 100 can be activated for energy absorption in order to support the emergency braking procedure of the vehicle 100.

According to one exemplary embodiment, the generating system 114 is designed to generate an emergency braking signal, by means of which a lighting system, and additionally or alternatively, a warning system of the vehicle 100 can be activated, in order to support the emergency braking procedure of the vehicle 100.

According to one exemplary embodiment, the device 110 is designed to generate an emergency braking signal, and to provide activations, by means of which control elements of a drive train of the vehicle 100 can be activated, in order to cause or support the emergency braking procedure of the vehicle 100. A combination of interventions defined below, in particular, is possible thereby.

If the transmission 190 has a converter clutch, a converter bypass can be shut off by means of the emergency braking signal, in order to reach a higher engine brake torque by means of downshifting and over-revving the engine 180. The converter is used as a retarder thereby. Other clutches in the transmission 190 can also be engaged, in order to generate further braking effects via friction in the disks thereof, and tension in the transmission 190. Moreover, a shifting while over-revving is possible by means of the emergency braking signal, even when the engine 180 may become damaged thereby.

If the engine 180 is an internal combustion engine, then an engine control device can be activated by means of the emergency braking signal, in order to cause an extreme pre-ignition and/or pre-injection, in order to already accumulate a supplementary engine brake torque in the compression stroke through fuel supply, or to reach a high rotation rate differential to a converter. If the engine 180 is an engine having variable valve control, it is possible to open the exhaust valve in the upper dead point, between the compression stroke and combustion stroke, in order to reduce the drive torque. If the engine 180 is not a free-wheeler, a reduction of the valve lift is caused by means of the emergency braking signal, in order to prevent a collision between the pistons and valves during more extreme over-revving. If the engine 180 has a turbocharger, then a control of pop-off and blow-by valves and/or a control of a turbine geometry can be implemented by means of the emergency braking signal, in order to increase an engine drag torque. If the engine is intended for a utility vehicle, for example, an exhaust valve brake and/or other supplementary brake devices 170 can be activated by means of the emergency braking signal.

If the engine 180 is an electric motor, then a motor control device can be activated by means of the emergency braking signal, in order to short a rotor, or to brake energy consumption through reverse power supply. Limited slip differentials and torque vectoring can also be used by means of the emergency braking signal to build up an increased tire slippage, in order to decrease drive power. Furthermore, other loads that are powered by the engine 180 can be activated by means of the emergency braking signal, such as an air conditioner, a generator recuperation and/or suchlike. Furthermore, a driving dynamics regulation or another assistance system can be activated by means of the emergency braking signal, in order to control brake circuits that remain functional. Lastly, a lighting system can also be activated by means of the emergency braking signal, in order to warn other road users by means of light, and optionally, hazard lights.

FIG. 2 shows a flow chart for a method 200 for generating an emergency braking signal for a vehicle, in accordance with an exemplary embodiment of the present invention. The vehicle has a main brake system and a drive system thereby. The vehicle is the vehicle from FIG. 1, or a similar vehicle. The method 200 can be executed in conjunction with a device for generating, like the device for generating from FIG. 1.

The method 200 has a step 210 for detecting a vehicle emergency, which represents a reduced or impaired braking effect by the main brake system, using at least one sensor signal that has been read in. The method 200 also has a step 220 for generating the emergency braking signal as a function of the detected vehicle emergency. The emergency braking signal is generated thereby, such that the main brake system, the drive system, a supplementary brake system, and additionally or alternatively, at least one further on board installation of the vehicle can be activated in order to cause or support an emergency braking procedure of the vehicle.

FIG. 3 shows a flow chart for a method 300 for initiating an emergency braking procedure of a vehicle, in accordance with an exemplary embodiment of the present invention. The vehicle has a main brake system and a drive system thereby. The vehicle is the vehicle form FIG. 1 or a similar vehicle. The method 200 can also be executed in conjunction with a vehicle like the vehicle from FIG. 1.

The method 300 has a step 310 for generating an emergency braking signal for a vehicle. Step 310, for generating, comprises sub-steps of the steps of the method for generating from FIG. 2. Thus, the method 300 can be executed in conjunction with the method for generating from FIG. 2. The method 300 can be executed in conjunction with a device for generating, like the device for generating from FIG. 1.

The method 300 also has a step 320, for activating the main brake system, the drive system, the supplementary brake system, and additionally or alternatively, the at least one further on board installation of the vehicle, by means of the emergency braking signal, in order to cause or support the emergency braking procedure of the vehicle.

The exemplary embodiments described herein and shown in the figures are selected only by way of example. Different exemplary embodiments can be combined with one another, either in their entirety or with respect to individual features. An exemplary embodiment can also be supplemented by features of another exemplary embodiment. Steps of the methods described herein can be executed repetitively.

### REFERENCE SYMBOLS

100 vehicle

110 device for generating an emergency braking signal

112 detection system

114 generating system

120 brake system sensor

130 engine rotation rate sensor

140 actuation sensor

150 gear selection device

160 main brake system

170 supplementary brake system

180 engine

190 transmission

200 method for generating an emergency braking signal

210 detection step

220 generating step

300 method for initiating an emergency braking procedure

310 generating step

320 activating step

1. A method for generating an emergency braking signal for a vehicle, wherein the vehicle comprises a main brake system and a drive system the method (200) comprising:
detecting a vehicle emergency via a reduced or impaired braking effect by the main brake system using at least one sensor signal that has been read in; and
generating the emergency braking signal as a function of the detected vehicle emergency, wherein the emergency braking signal may activate the main brake system, the drive system, a supplementary brake system, and/or at least one on board installation of the vehicle to cause or support an emergency braking procedure of the vehicle.

2. The method of claim 1, wherein detecting a vehicle emergency comprises detecting a failure of the main brake system using the at least one sensor signal that has been read in, the at least one sensor signal representing a brake slippage, a hydraulic brake circuit system pressure, an engine rotation rate, at least one property of an actuation procedure at a gear selection device, and/or a datum from a driver assistance system of the vehicle.

3. The method of claim 2, wherein generating the emergency braking signal as a function of the detected vehicle emergency comprises the emergency braking signal being generated by the drive system, the supplementary brake system, and/or the at least one on board installation of the vehicle being activated to cause or support the emergency braking procedure.

4. The method of claim 1, wherein detecting a vehicle emergency comprises detecting an impairment of a driver of the vehicle using the at least one sensor signal that has been read in from an interior camera, a contact sensor on a steering wheel, a contact sensor on a gear selection device and/or a driver assistance system of the vehicle.

5. The method of claim 1, wherein generating the emergency braking signal as a function of the detected vehicle emergency comprises at least one transmission device of the vehicle being activated to increase a tire slippage, a drag torque and/or an engine brake torque to cause or support the emergency braking procedure of the vehicle.

6. The method of claim 1, wherein generating the emergency braking signal as a function of the detected vehicle emergency comprises an engine control device, an exhaust valve control device and/or a valve control device of the drive system being activated to increase an engine drag torque and/or an engine brake torque to cause or support the emergency braking procedure of the vehicle.

7. The method of claim 1, wherein generating the emergency braking signal as a function of the detected vehicle emergency comprises the at least one on board installation supplied with power from an engine of the vehicle being activated to support the emergency braking procedure of the vehicle.

8. The method of claim 1, wherein generating the emergency braking signal as a function of the detected vehicle emergency comprises at least one lighting system and/or a warning system of the vehicle being activated to activate hazard lights, a horn, and/or driving lights, in order to support the emergency braking procedure of the vehicle.

9. A method for initiating an emergency braking procedure of a vehicle, wherein the vehicle comprises a main brake system and a drive system, the method comprising:
detecting a vehicle emergency via a reduced or impaired braking effect by the main brake system using at least one sensor signal that has been read in;
generating the emergency braking signal as a function of the detected vehicle emergency, wherein the emergency braking signal may activate the main brake system, the drive system, a supplementary brake system, and/or at least one on board installation of the vehicle to cause or support an emergency braking procedure of the vehicle; and
activating the main brake system, the drive system, the supplementary brake system, and/or the at least one on board installation of the vehicle by means of the emergency braking signal to cause or support the emergency braking procedure of the vehicle.

10. A device for generating an emergency braking signal for a vehicle, wherein the vehicle comprises a main brake system and a drive system, the device comprising:
a system for detecting a vehicle emergency via a reduced or impaired braking effect of the main brake system using at least one sensor signal that has been read in; and
a system for generating the emergency braking signal as a function of the detected vehicle emergency, wherein the emergency braking signal may activate the main brake system, the drive system, a supplementary brake system, and/or at least one on board installation of the vehicle to cause or support an emergency braking procedure of the vehicle.

11. (canceled)

12. The method of claim 2, wherein generating the emergency braking signal as a function of the detected vehicle emergency comprises at least one transmission device of the vehicle being activated to increase a tire slippage, a drag torque and/or an engine brake torque to cause or support the emergency braking procedure of the vehicle.

13. The method of claim 4, wherein generating the emergency braking signal as a function of the detected vehicle emergency comprises at least one transmission device of the vehicle being activated to increase a tire slippage, a drag torque and/or an engine brake torque to cause or support the emergency braking procedure of the vehicle.

14. The method of claim 2, wherein generating the emergency braking signal as a function of the detected vehicle emergency comprises engine control device, an exhaust valve control device and/or a valve control device of the drive system being activated to increase an engine drag torque and/or an engine brake torque to cause or support the emergency braking procedure of the vehicle.

15. The method of claim 4, wherein generating the emergency braking signal as a function of the detected vehicle emergency comprises engine control device, an exhaust valve control device and/or a valve control device of the drive system being activated to increase an engine drag torque and/or an engine brake torque to cause or support the emergency braking procedure of the vehicle.

16. The method of claim 2, wherein generating the emergency braking signal as a function of the detected vehicle emergency comprises the at least one on board installation supplied with power from an engine of the vehicle being activated to support the emergency braking procedure of the vehicle.

17. The method of claim 4, wherein generating the emergency braking signal as a function of the detected vehicle emergency comprises the at least one on board installation supplied with power from an engine of the vehicle being activated to support the emergency braking procedure of the vehicle.

18. The method of claim 2, wherein generating the emergency braking signal as a function of the detected vehicle emergency comprises at least one lighting system and/or a warning system of the vehicle being activated to activate hazard lights, a horn, and/or driving lights, in order to support the emergency braking procedure of the vehicle.

19. The method of claim 4, wherein generating the emergency braking signal as a function of the detected vehicle emergency comprises at least one lighting system and/or a warning system of the vehicle being activated to activate hazard lights, a horn, and/or driving lights, in order to support the emergency braking procedure of the vehicle.

20. The method of claim 9, wherein detecting a vehicle emergency comprises detecting a failure of the main brake system using the at least one sensor signal that has been read in, the at least one sensor signal representing a brake slippage, a hydraulic brake circuit system pressure, an engine rotation rate, at least one property of an actuation procedure at a gear selection device, and/or a datum from a driver assistance system of the vehicle.
